(19) United States
(12) Patent Application Publication
(10) Pub. No.: US 2009/0063496 A1
(43) Pub. Date: Mar. 5, 2009

(54) AUTOMATED MOST POPULAR MEDIA ASSET CREATION

(75) Inventors: Ryan B. Cunningham, San Francisco, CA (US); Chris Kalaboukis, Los Gatos, CA (US)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 11/847,199

(22) Filed: Aug. 29, 2007

(51) Int. Cl. G06F 17/30

(52) U.S. Cl. 707/10; 707/E17.032

(57) ABSTRACT

A method for automatically generating most popular videos or aggregate media assets based on a set of criteria is provided. In one example, the method includes receiving a set of criteria (e.g., one or more criterion) for selecting media assets, selecting at least two media assets from a plurality of media assets based on a set of data (e.g., one or more attributes) associated with each of the plurality of media assets and the set of criteria, and generating a playlist of the selected media assets. The method may further include generating an aggregate media asset based on the playlist for sequentially playing media assets according to the playlist. The selection criteria may be based upon a media asset attribute (e.g., duration, subject matter, source, language, etc.). Further, selection of the media assets may be based on media asset access patterns, e.g., views, plays, edits, etc.

### RELATED APPLICATIONS

The present application is related to U.S. patent application Ser. Nos. 11/784,843, 11/784,918, 11/786,016, and 11/786,020, all of which were filed on Apr. 9, 2007, and all of which are hereby incorporated by reference herein in their entirety.

### BACKGROUND

1. Field

The present invention relates generally to systems and methods for the generation of media assets such as video and/or audio assets via a network, such as the Internet or an intranet, and in particular, to systems and methods for automatically creating movies or aggregate media assets based on a set of criteria.

2. Description of Related Art

Currently there exist many different types of media assets in the form of digital files that are transmitted via the Internet. Digital files may contain data representing one or more types of content, including but not limited to, audio, images, and videos. For example, media assets include file formats such as MPEG-1 Audio Layer 3 (“MP3”) for audio, Joint Photographic Experts Group (“JPEG”) for images, Motion Picture Experts Group (“MPEG-2” and “MPEG-4”) for video, Adobe Flash for animations, and executable files.

Users currently go to various web sites and manually select and play the videos, images, or music clips that interest them. For example, users interested in the latest baseball information may go to the web site Yahoo!® Sports, browse through its web pages, and manually play the latest baseball videos. Top-lists maintained on the web site also help users to locate the most popular and latest sports videos. Users may also enter key words or tags to search for more specific videos, such as videos about a particular baseball player or team.

Selecting and playing videos in the manner described above is generally a manual and time-consuming process. Therefore, a system that automatically generates videos or aggregate media assets based on a set of criteria, such as duration and preferred subject matter, is a desirable feature. Such a system may require fewer user interactions and provide users a more passive and satisfying experience.

### SUMMARY

According to one aspect of the present invention, methods for automatically generating videos or aggregate media assets based on a set of criteria are provided. In one example, the method includes receiving a set of criteria (e.g., one or more criterion) for selecting media assets, selecting at least two media assets from a plurality of media assets based on a set of data (e.g., one or more attributes) associated with each of the plurality of media assets and the set of criteria, and generating a playlist of the selected media assets. The method may further include generating an aggregate media asset based on the playlist for sequentially playing media assets according to the playlist.

The method may further include tracking a set of data associated with each of the media assets. In one example, the selection criteria may be based upon a media asset attribute, such as the duration, subject matter, source, language of the media asset, and the like. A media asset attribute may be a tag associated with the media asset or the geographical region where the media asset may have relevance. In one example, the selection criteria may be based upon a ranking in accordance with the set of data for the plurality of media assets. The ranking may be based on a media asset access pattern, such as the number of times users access a media asset, the number of times users play a media asset, the percentage of times users play a media asset in its entirety, the average start and end time of a media asset, portions of the media asset used or indicated as being interesting, and the like. The ranking may also be based on an aggregate user input ranking, such as the number of users who have designated a media asset as a favorite, the number of users who have endorsed a media asset, and the like. In one example, the selection criteria may also be based upon a user profile preference.

According to another aspect of the present invention, apparatus for automatically generating videos or aggregate media assets based on a set of criteria is provided. In one example, the apparatus includes logic for causing the selection of at least a portion of at least one media asset from the plurality of media assets for use in an aggregate media asset, the selection satisfying at least one selection criteria in accordance with the set of data. The apparatus further includes logic for causing the generation of a playlist of the aggregate media asset, the generation satisfying the at least one selection criteria in accordance with the set of data. The apparatus may further include logic for tracking a set of data for a plurality of media assets and/or causing communication of the playlist or aggregate media asset to another device (e.g., a media server or user device).

In another aspect, a computer-readable medium comprising instructions for generating a media asset is provided. In one example, the instructions may be for causing the method comprising receiving a set of criteria for selecting media assets, selecting at least two media asset from a plurality of media assets for use in an aggregate media asset, wherein the aggregate media asset satisfies the set of criteria in accordance with a set of data for the plurality of media assets, and generating a playlist of the selected media assets. The instructions may further cause tracking a set of data for a plurality of media assets and/or causing communication of the playlist or aggregate media asset to another device (e.g., a media server or user device).

The various aspects and examples of the present inventions are better understood upon consideration of the detailed description below in conjunction with the accompanying drawings and claims.

### BRIEF DESCRIPTION OF THE DRAWINGS

The following drawing figures, which form a part of this application, are illustrative of embodiments, systems, and methods described below and are not meant to limit the scope of the invention in any manner, which scope shall be based on the claims appended hereto.

FIG. 1 illustrates a block diagram of an exemplary environment in which certain aspects of the system and methods described may operate.

FIG. 2 illustrates an embodiment of a method for generating a media asset.

FIG. 3 illustrates an embodiment of a system for manipulating a media asset in a networked computing environment.

FIG. 4 illustrates an embodiment of a system for manipulating a media asset in a networked computing environment.

FIG. 5 illustrates an exemplary computing system that may be employed to implement processing functionality for various aspects of the invention.

### DETAILED DESCRIPTION

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

One aspect of the present invention includes a method and system for automatically generating aggregate media assets (e.g., videos) based on a set of criteria. Broadly speaking, and in one example, the system stores media assets in a media asset library accessible through servers, which are connected to the Internet. For each media asset, the system stores and tracks a set of data (the set may include one or more attributes), which can be used to determine a ranking of the media asset for a given set of criteria (in one example, the “interestingness” of the media asset for a given set of criteria). For example, the set of data may include various attributes, access patterns, or user input rankings of the media assets. The set of criteria may be entered by a user. For example, a user may request for a movie with the most popular music videos on a particular site that has a total playtime of less than 30 minutes. Alternatively, the system may provide a few sets of criteria and allow a user to select one of the sets, e.g., a selection for most popular sports videos of the day and the like. In yet another example, the system may use a user profile to determine the set of criteria.

The system selects media assets satisfying the set of criteria for use in a new aggregate media asset. An edit specification for editing and generating the new aggregate media asset from the selection of media assets is then generated by the system. In one example, the system further generates the new aggregate media asset and causes it to be played at the client device for the user. In another example, only the edit specification is transferred to the client for rendering of the aggregate media asset.

In one example, the system tracks the attributes of each media asset, such as the title, duration, subject matter, language of the media asset, and the like. Other attributes may include the geographical region where the media asset may have relevance, the source from which the media asset originates from, and the tags that are associated with the media asset. In another example, as users access these media assets, the system may also track each media asset's access patterns, such as the number of times users access the media asset, the number of times users play the media asset, the percentage of times users play the media asset in its entirety, at what points the media asset is usually started and stopped, portions of the media asset used or indicated as being interesting, and the like. In another example, the system may also track each media asset's aggregate user input rankings, such as the number of users who have designated the media asset as a favorite, the number of users who have endorsed the media asset, and the like.

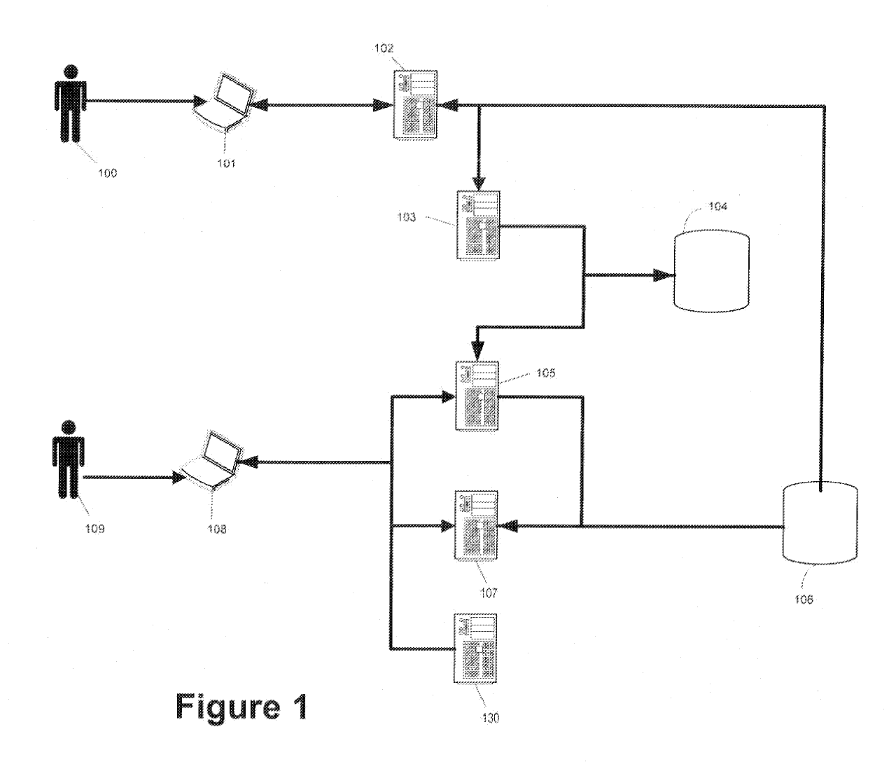

FIG. 1 illustrates a block diagram of an exemplary environment in which certain aspects of the system and methods described may operate. Generally, media assets such as videos, music, images, and the like are stored in media asset library 106 (e.g., a database or media store system). New media assets may be added to the media asset library 106 from users, content providers, and the like. For example, a system administrator may manually load new media assets from local devices to the media asset library 106. In another example, the system may automatically grab or receive new media assets from various web sites or content providers, and load the new media assets into the Media asset library 106. In yet another example, a user may upload media assets via client device 101 to media asset library 106 for storage, where the media assets may include user-created or user-generated media assets.

In one example, as some of these media assets become outdated, they may be removed from the media asset library 106. Further, as new media assets are stored and old media assets are removed, media tracking server 103 and/or media meta data store 104 may track and store the attributes of the media assets currently residing in the media asset library 106. For example, the system stores and/or tracks the attributes of each media asset, such as the title, duration, subject matter, language of the media asset, and the like. Other attributes may include the geographical region where the media asset may have relevance, the source from which the media asset originates from, and the tags that are associated with the media asset.

User 100 may browse or play the collection of media assets stored in media asset library 106 via client 101, which is connected to the media asset library 106 through the media server 102. The access patterns of the media assets may be tracked and stored by the media tracking server 103 and/or the media meta data store 104. A wide range of data for each media asset may be tracked including both implicit data, such as the number of times users view a video, the number of times it is played, where the video is started and stopped, and the like, as well as explicit data such votes or rankings of a video by users, the use of clips in other videos, and the like (where the data may be used in various manners to determine a ranking or scoring of the media assets for particular criteria, and which may be used to create an aggregate media asset). For example, as user 100 accesses these media assets, the system may track each media asset's access patterns such as the number of times users access the media asset, the number of times users play the media asset, the percentage of times users play the media asset in its entirety, the percentage of times users stop the media asset within a short period of time, at what points the media asset is usually started and stopped, and the like.

Additionally, in some examples, a user 100 may have the option to rate or rank a media asset. For example, user 100 may designate a media asset as “my favorite,” “recommended,” “most interesting,” “most creative,” “most weird”, and the like. User 100 may be asked to rate the media assets (e.g., on a scale of one to ten). The media tracking server 103 and/or the media meta data store 104 may then track and store each media asset's aggregate user input rankings, such as the number of users who have designated the media asset as a favorite, the number of users who have endorsed the media asset, and the like.

User 109 (or user 101) may request media assets according to a selected set of criteria via client device 108. For example, a user may specify a set of criteria to retrieve one or more media assets from media asset library 106. Alternatively, the system may provide several sets of criteria (e.g., categories) and allow a user to select from amongst the sets. User 109 may specify subjects or topics, time durations, language, and so on. For example, a user on a commuter train trip which takes an hour, may request a particular topic and time duration for a desired media asset. The user may access media server 107 from a mobile phone or WI-FI enabled laptop and select “Watch Most Popular for 60 minutes” or “Watch Funniest for 30 minutes, then watch documentaries for 30 minutes.” In another example, user 109 may request for a slide show with the “most interesting” content in the skateboarding space, without any duration limitation. In another example, user 109 may request for 30 minutes of the most popular alternative music. In yet another example, user 109 may enter “mustang” and “race” as tags. If the tags are too narrow, the system may use similar tags or factor in what other viewers find interesting in order to select the best clips to show.

In one example, media server 107 and/or media playlist server 105 may use a user profile associated with user 109 to formulate some or all of the set of selection criteria. For example, if the profile indicates that user 109 a child, media assets designated as “adult material” may be filtered or blocked. In another example, if the profile indicates user 109 speaks Spanish and is located in South America, news in Spanish relevant to South America may be scored or ranked higher during the selecting process (or only such news selectable). If user 109 has a set of preferences stored in his user profile, the system may provide user 109 with a “personal video channel.” For example, user 109 may be interested in news only from NYTimes.com and CNN.com, and in particular, news about poker tournaments and politics. Accordingly, a new media asset based on these criteria could be loaded-up with most recent media assets displayed first, for example.

In one example, client 108 communicates a set of criteria input from user 109 to the media playlist server 105. The media playlist server 105 may then use the attributes, access patterns, or user input rankings stored in the media meta data store 104 to build a playlist (which includes one or more edit specifications) satisfying the set of criteria. For example, the media assets may be scored and ranked based on the set of criteria and played sequentially in order (until all media assets satisfying the criteria have been displayed, for a given duration, or the like). Any scoring mechanism may be applied to the media assets.

In one example for retrieving the most popular media assets, an “interestingness” algorithm may be used, which generally includes assigning a media asset a score based on various user actions or patterns taken with respect to each media asset. For example, a media asset may be given 1 point for each view of the media asset, 3 points for each user entered comment regarding the media asset, 5 points for each user use or download of the media asset, between positive 3 and negative 3 points for user entered ratings of the media asset, 2 points for user entered tags, and so on. The points may then be used to rank and play the media assets. The above factors and attributes are illustrative only and various other factors or attributes may be used to score the media assets. Other exemplary methods for scoring and ranking the media assets are described, e.g., in U.S. patent application Ser. No. 11/350,635, filed Feb. 8, 2006, the entire contents of which are incorporated herein in its entirety.

In one example, the interestingness algorithm may be used not only to determine particular media assets, but also specific portions of the media asset to be used in the aggregate media asset. For example, a user may indicate particular sections of a video they like by selecting a button during portions, using or grabbing certain portions frequently, and so on. Accordingly, the interestingness data may include sections of larger videos, and the assembled aggregate media asset including those interesting sections.

The playlist or edit specification is then sent to the media server 107, which generates the aggregate media asset based on the media assets stored in media asset library 106. The aggregate media asset may then be sent to client 108 for playback; for example, media playlist server 105 may cause media server 107 to queue up and stream or play the clips as a single movie to client 108. In another example, the aggregate media asset may be sent to client 108 for storage, and user 109 may download it to a portable media player at a later time, for example.

In one example, when user 109 watches the aggregate media asset, user 109 can provide feedback, such as thumb up/down selection, skip until the end, or otherwise ranking or scoring the media asset. Such feedback may be communicated to the media tracking server 103 and/or the media meta data store 104. Alternatively, the feedback may be sent to the media playlist server 105 such that the playlist may be reformulated based on the feedback of user 109.

Additionally, an advertisement server 130 may operate to cause the delivery of an advertisement to client 108. Advertisement server 130 may also associate advertisements with media assets/edit specifications transmitted to or from client 108. For example, advertisement server 130 may include logic for causing advertisements to be displayed with or associated with delivered media assets or edit specifications based on various factors such as the media assets generated, accessed, viewed, uploaded, and/or edited, as well as other user activity data associated therewith. In other examples, the advertisements may alternatively or additionally be based on activity data, context, user profile information, or the like associated with client 108 or a user thereof (e.g., accessed via client 108 or an associated web server). In yet other examples, the advertisements may be randomly generated or associated with client 108 or media assets and delivered to client 108.

It will be recognized that media tracking server 103, media meta data store 104, media playlist server 105, media server 107, and advertisement server 130 are illustrated as separate items or devices for illustrative purposes only. In some examples, the various features may be included in whole or in part with a common server device, server system, or provider network (e.g., a common backend), or the like; conversely, individually shown devices may comprise multiple devices and be distributed over multiple locations. Further, various additional servers and devices may be included such as web servers, mail servers, mobile servers, and the like as will be understood by those of ordinary skill in the art.

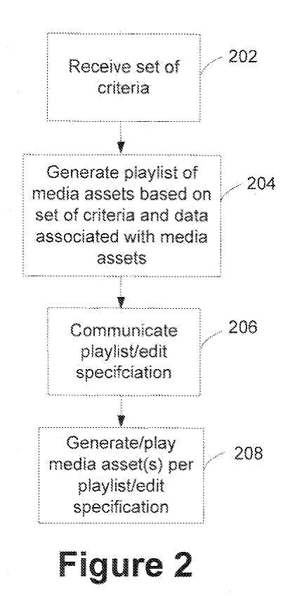

FIG. 2 illustrates an exemplary method for generating a media asset based on a set of criteria. In one example, the method is a computer-implemented method, which may be carried out by software operating on one or more computing devices, e.g., a server device, client device, and the like.

In one example, the method includes receiving a set of criteria at block 202. The set of criteria may be received from a user device, e.g., in response to user input and/or from information of a user profile, which may be stored with a service provider. The set of criteria may include one or more criteria for selecting media assets for an aggregate media asset.

The method further includes generating a playlist or edit specification of media assets based on the received set of criteria and data associated with the media assets at block 204. For example, a playlist may identify the media assets and the order in which to play the media assets as determined based on the set of criteria and a determined ranking of media assets according to the set of criteria. The playlist may further include an edit specification or other data for editing the media assets (e.g., if only a portion of a media asset is to be played).

The playlist may be communicated at block 206 to a client device or to a media server, for example. In one example, where the playlist is communicated to a user device, the user device may then request or access the media assets per the playlist to display the selected media assets. In another example, the playlist may be communicated to a media server or used by the server generating the playlist to generate an aggregate media asset based on the playlist at block 208, where the generated media asset is then communicated to a user device. In yet other examples, a playlist per se is not created; rather an aggregate media asset and/or associated edit specification is generated based on the set of criteria and data associated with the media assets and communicated to a user device.

It will be recognized that various portions of the described method may be carried out by different devices. For example, a first server may receive the set of criteria and pass that to a media server for generating a playlist and aggregate media asset. Further, certain portions may be omitted; for example, block 206 may not be needed depending on the particular implementation and architecture.

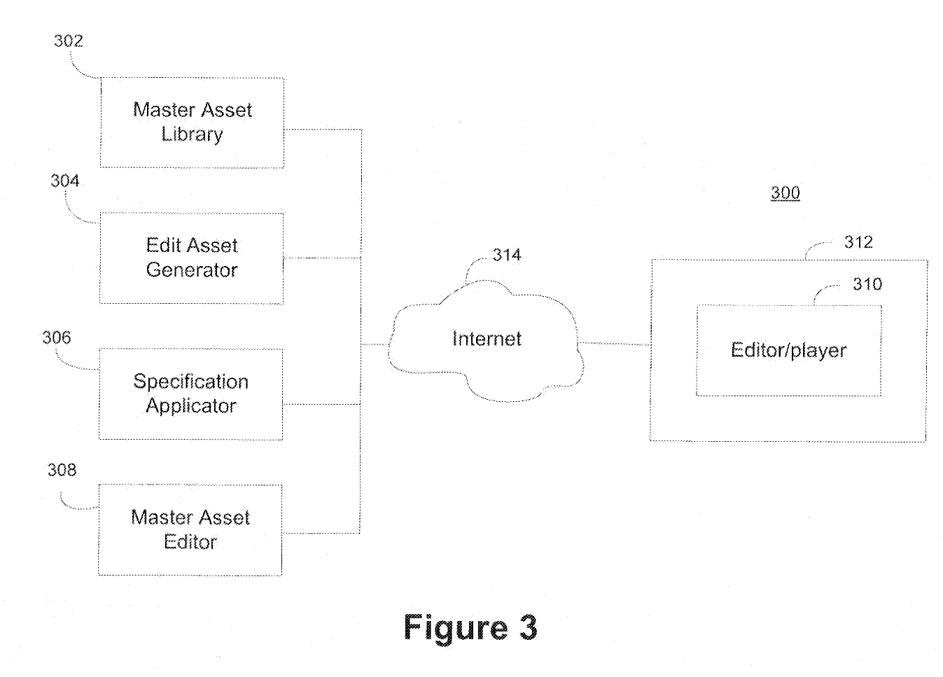

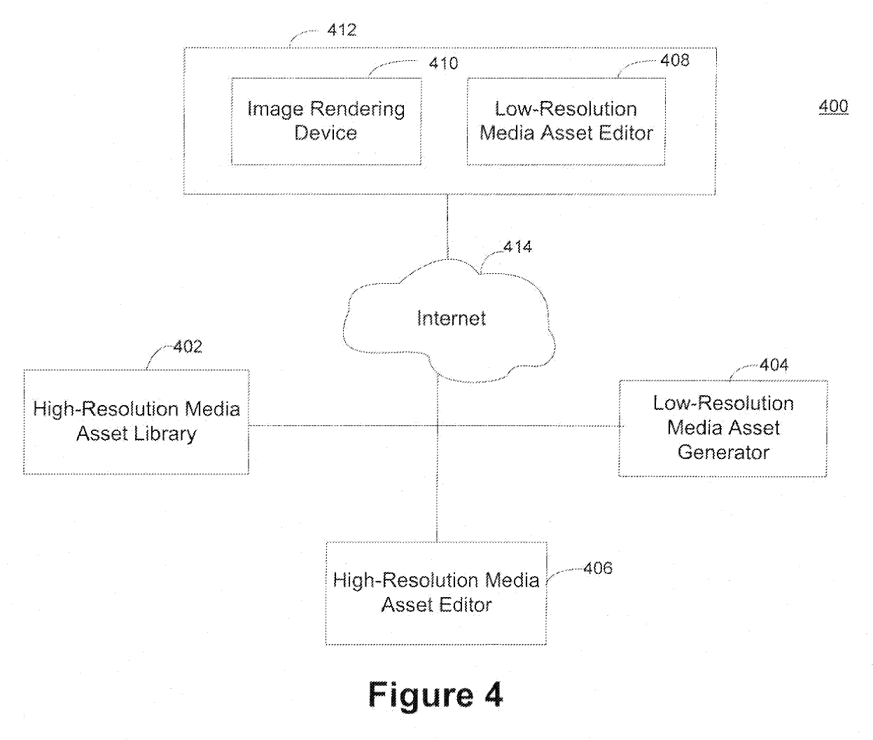

One skilled in the art will recognize that many different systems and methods can facilitate the generation of a media asset and communication to a device as described. One exemplary system and method is described in FIGS. 3 and 4 below. For instance, the following describes a system and method for allowing a user to view and/or edit a low-resolution version of a remotely stored high-resolution media asset (e.g., stored in a media asset library). This is illustrative of one particular example, and it will be understood other systems and methods for communicating media assets to remote users are possible and contemplated. For example, various known media players and/or web based editor applications may be similarly used to implement the invention described.

FIG. 3 illustrates an exemplary system 300 for generating a media asset as described. In one example, system 300 is comprised of a master asset library 302. In one example, a master asset library 302 may be a logical grouping of data, including but not limited to high-resolution and low-resolution media assets. In another embodiment, a master asset library 302 may be a physical grouping of data, including but not limited to high-resolution and low-resolution media assets. In an embodiment, a master asset library 302 may be comprised of one or more databases and reside on one or more servers. In one embodiment, master asset library 302 may be comprised of a plurality of libraries, including public, private, and shared libraries. In one embodiment, a master asset library 302 may be organized into a searchable library. In another embodiment, the one or more servers comprising master asset library 302 may include connections to one or more storage devices for storing digital files.

For purposes of this disclosure, the drawings associated with this disclosure, and the appended claims, the term “files” generally refers to a collection of information that is stored as a unit and that, among other things, may be retrieved, modified, stored, deleted or transferred. Storage devices may include, but are not limited to, volatile memory (e.g., RAM, DRAM), non-volatile memory (e.g., ROM, EPROM, flash memory), and devices such as hard disk drives and optical drives. Storage devices may store information redundantly. Storage devices may also be connected in parallel, in a series, or in some other connection configuration. As set forth in the present embodiment, one or more assets may reside within a master asset library 302.

For purposes of this disclosure, the drawings associated with this disclosure, and the appended claims, an “asset” refers to a logical collection of content that may be comprised within one or more files. For example, an asset may be comprised of a single file (e.g., an MPEG video file) that contains images (e.g., a still frame of video), audio, and video information. As another example, an asset may be comprised of a file (e.g., a JPEG image file) or a collection of files (e.g., JPEG image files) that may be used with other media assets or collectively to render an animation or video. As yet another example, an asset may also comprise an executable file (e.g., an executable vector graphics file, such as an SWF file or an FLA file). A master asset library 302 may include many types of assets, including but not limited to, video, images, animations, text, executable files, and audio. In one embodiment, master asset library 302 may include one or more high-resolution master assets. For the remainder of this disclosure, “master asset” will be disclosed as a digital file containing video content. One skilled in the art will recognize, however, that a master asset is not limited to containing video information, and as set forth previously, a master asset may contain many types of information including but not limited to images, audio, text, executable files, and/or animations.

In one embodiment, a media asset may be stored in a master asset library 302 so as to preserve the quality of the media asset. For example, in the case of a media asset comprising video information, two important aspects of video quality are spatial resolution and temporal resolution. Spatial resolution generally describes the clarity of lack of blurring in a displayed image, while temporal resolution generally describes the smoothness of motion. Motion video, like film, consists of a certain number of frames per second to represent motion in the scene. Typically, the first step in digitizing video is to partition each frame into a large number of picture elements, or pixels or pels for short. The larger the number of pixels, the higher the spatial resolution. Similarly, the more frames per second, the higher the temporal resolution.

In one embodiment, a media asset may be stored in a master asset library 302 as a master asset that is not directly manipulated. For example, a media asset may be preserved in a master asset library 302 in its original form, although it may still be used to create copies or derivative media assets (e.g., low-resolution assets). In one embodiment, a media asset may also be stored in a master asset library 302 with corresponding or associated assets. In one embodiment, a media asset stored in a master asset library 302 may be stored as multiple versions of the same media asset. For example, multiple versions of a media asset stored in master asset library 302 may include an all-keyframe version that does not take advantage of intra-frame similarities for compression purposes, and an optimized version that does take advantage of intra-frame similarities. In one embodiment, the original media asset may represent an all-keyframe version. In another embodiment, the original media asset may originally be in the form of an optimized version or stored as an optimized version. One skilled in the art will recognize that media assets may take many forms within a master asset library 302 that are within the scope of this disclosure.

In one embodiment, a system 300 is also comprised of an edit asset generator 304. In an embodiment, an edit asset generator 304 may be comprised of transcoding hardware and/or software that, among other things, may convert a media asset from one format into another format. For example, a transcoder may be used to convert an MPEG file into a Quicktime file. As another example, a transcoder may be used to convert a JPEG file into a bitmap (e.g., *.BMP) file. As yet another example, a transcoder may standardize media asset formats into a Flash video file (*.FLV) format. In one embodiment, a transcoder may create more than one versions of an original media asset. For example, upon receiving an original media asset, a transcoder may convert the original media asset into a high-resolution version and a low-resolution version. As another example, a transcoder may convert an original media asset into one or more files. In one embodiment, a transcoder may exist on a remote computing device. In another embodiment, a transcoder may exist on one or more connected computers. In one embodiment, an edit asset generator 304 may also be comprised of hardware and/or software for transferring and/or uploading media assets to one or more computers. In another embodiment, an edit asset generator 304 may be comprised of or connected to hardware and/or software used to capture media assets from external sources such as a digital camera.

In one embodiment, an edit asset generator 304 may generate a low-resolution version of a high-resolution media asset stored in a master asset library 302. In another embodiment, an edit asset generator 304 may transmit a low-resolution version of a media asset stored in a master asset library 302, for example, by converting the media asset in real-time and transmitting the media asset as a stream to a remote computing device. In another embodiment, an edit asset generator 304 may generate a low quality version of another media asset (e.g., a master asset), such that the low quality version preserves while still providing sufficient data to enable a user to view and apply edits to the low quality version.

In one embodiment, a system 300 may also be comprised of a specification applicator 306. In one embodiment, a specification applicator 306 may be comprised of one or more files or edit specifications that include edit instructions for editing and modifying a media asset (e.g., a high-resolution media asset). In one embodiment, a specification applicator 306 may include one or more edit specifications that comprise modification instructions for a high-resolution media asset based upon edits made to a corresponding or associated low-resolution media asset. In one embodiment, a specification applicator 306 may store a plurality of edit specifications in one or more libraries.

In one embodiment, a system 300 is also comprised of a master asset editor 308 that may apply one or more edit specifications to a media asset. For example, a master asset editor 308 may apply an edit specification stored in a specification applicator 306 library to a first high-resolution media asset and thereby creates another high-resolution media asset, e.g., a second high-resolution media asset. In one embodiment, a master asset editor 308 may apply an edit specification to a media asset in real-time. For example, a master asset editor 308 may modify a media asset as the media asset is transmitted to another location. In another embodiment, a master asset editor 308 may apply an edit specification to a media asset in non-real-time. For example, a master asset editor 308 may apply edit specifications to a media asset as part of a scheduled process. In one embodiment, a master asset editor 308 may be used to minimize the necessity of transferring large media assets over a network. For example, by storing edits in an edit specification, a master asset editor 308 may transfer small data files across a network to effectuate manipulations made on a remote computing device to higher quality assets stored on one or more local computers (e.g., computers comprising a master asset library).

In another embodiment, a master asset editor 308 may be responsive to commands from a remote computing device (e.g., clicking a “remix” button at a remote computing device may command the master asset editor 308 to apply an edit specification to a high-resolution media asset). For example, a master asset editor 308 may dynamically and/or interactively apply an edit specification to a media asset upon a user command issuing from a remote computing device. In one embodiment, a master asset editor 208 may dynamically apply an edit specification to a high-resolution to generate an edited high-resolution media asset for playback. In another embodiment, a master asset editor 308 may apply an edit specification to a media asset on a remote computing device and one or more computers connected by a network (e.g., Internet 314). For example, bifurcating the application of an edit specification may minimize the size of the edited high-resolution asset prior to transferring it to a remote computing device for playback. In another embodiment, a master asset editor 308 may apply an edit specification on a remote computing device, for example, to take advantage of vector-based processing that may be executed efficiently on a remote computing device at playtime.

In one embodiment, a system 300 is also comprised of an editor/player 310 that may reside on a remote computing device 312 that is connected to one or more networked computers, such as the Internet 314. In one embodiment, an editor/player 310 may be comprised of software. For example, editor/player 310 may be a stand-alone program. As another example, editor/player 310 may be comprised of one or more instructions that may be executed through another program such as an Internet 314 browser (e.g., Microsoft Internet Explorer). In one embodiment, editor/player 310 may be designed with a user interface similar to other media-editing programs. In one embodiment, editor/player 310 may contain connections to a master asset library 302, an edit asset library 304, a specification applicator 306 and/or a master asset editor 308. In one embodiment, editor/player 310 may include pre-constructed or “default” edit specifications that may be applied by a remote computing device to a media asset. In one embodiment, editor/player 310 may include a player program for displaying media assets and/or applying one or more instructions from an edit specification upon playback of a media asset. In another embodiment, editor/player 310 may be connected to a player program (e.g., a standalone editor may be connected to a browser).

FIG. 4 illustrates an embodiment of a system 400 for generating a media asset, for example, in response to receiving a set of criteria and/or playlist. In one embodiment, the system 400 comprises a high-resolution media asset library 402. In one embodiment, the high-resolution media asset library 402 may be a shared library, a public library, and/or a private library. In one embodiment, the high-resolution media asset library 402 may include at least one video file. In another embodiment, the high resolution media asset library 402 may include at least one audio file. In yet another embodiment, the high-resolution media asset library 402 may include at least one reference to a media asset residing on a remote computing device 412. In one embodiment, the high-resolution media asset library 402 may reside on a plurality of computing devices.

In one embodiment, the system 400 further comprises a low-resolution media asset generator 404 that generates low-resolution media assets from high-resolution media assets contained in the high-resolution media asset library. For example, as discussed above, a low-resolution media asset generator 404 may convert a high-resolution media asset to a low-resolution media asset.

In one embodiment, the system 400 further comprises a low-resolution media asset editor 408 that transmits edits made to an associated low-resolution media asset to one or more computers via a network, such as the Internet 414. In another embodiment, the low-resolution media asset editor 408 may reside on a computing device remote from the high resolution media asset editor, for example, remote computing device 412. In another embodiment, the low-resolution media asset editor 408 may utilize a browser. For example, the low-resolution media asset editor 408 may store low-resolution media assets in the cache of a browser.

In one embodiment, the system 400 may also comprise an image rendering device 410 that displays the associated low-resolution media asset. In one embodiment, an image rendering device 410 resides on a computing device 412 remote from the high-resolution media asset editor 406. In another embodiment, an image rendering device 410 may utilize a browser. In one embodiment, the system 400 further comprises a high-resolution media asset editor 406 that applies edits to a high-resolution media asset based on edits made to an associated low-resolution media asset.

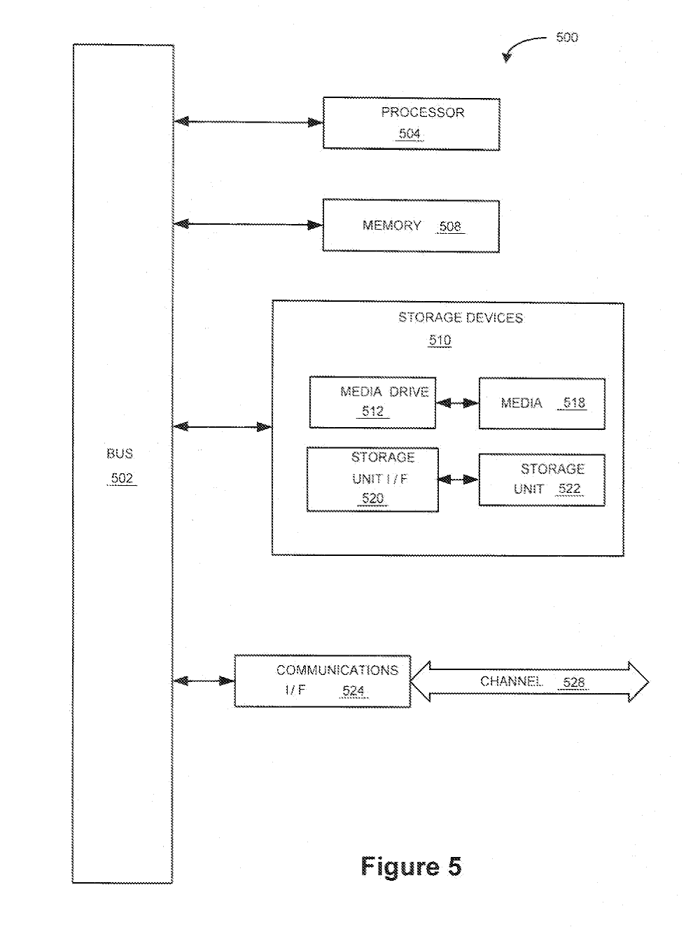

FIG. 5 illustrates an exemplary computing system 500 that may be employed to implement processing functionality for various aspects of the invention (e.g., as a user/client device, media server, media playlist server, media meta data store, media asset library, activity data logic/database, combinations thereof, etc.). Those skilled in the relevant art will also recognize how to implement the invention using other computer systems or architectures. Computing system 500 may represent, for example, a user device such as a desktop, mobile phone, personal entertainment device, DVR, and so on, a mainframe, server, or any other type of special or general purpose computing device as may be desirable or appropriate for a given application or environment. Computing system 500 can include one or more processors, such as a processor 504. Processor 504 can be implemented using a general or special purpose processing engine such as, for example, a microprocessor, microcontroller or other control logic. In this example, processor 504 is connected to a bus 502 or other communication medium.

Computing system 500 can also include a main memory 508, preferably random access memory (RAM) or other dynamic memory, for storing information and instructions to be executed by processor 504. Main memory 508 also may be used for storing temporary variables or other intermediate information during execution of instructions to be executed by processor 504. Computing system 500 may likewise include a read only memory (“ROM”) or other static storage device coupled to bus 502 for storing static information and instructions for processor 504.

The computing system 500 may also include information storage mechanism 510, which may include, for example, a media drive 512 and a removable storage interface 520. The media drive 512 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 518 may include, for example, a hard disk, floppy disk, magnetic tape, optical disk, CD or DVD, or other fixed or removable medium that is read by and written to by media drive 514. As these examples illustrate, the storage media 518 may include a computer-readable storage medium having stored therein particular computer software or data.

In alternative embodiments, information storage mechanism 510 may include other similar instrumentalities for allowing computer programs or other instructions or data to be loaded into computing system 500. Such instrumentalities may include, for example, a removable storage unit 522 and an interface 520, such as a program cartridge and cartridge interface, a removable memory (for example, a flash memory or other removable memory module) and memory slot, and other removable storage units 522 and interfaces 520 that allow software and data to be transferred from the removable storage unit 518 to computing system 500.

Computing system 500 can also include a communications interface 524. Communications interface 524 can be used to allow software and data to be transferred between computing system 500 and external devices. Examples of communications interface 524 can include a modem, a network interface (such as an Ethernet or other NIC card), a communications port (such as for example, a USB port), a PCMCIA slot and card, etc. Software and data transferred via communications interface 524 are in the form of signals which can be electronic, electromagnetic, optical, or other signals capable of being received by communications interface 524. These signals are provided to communications interface 524 via a channel 528. This channel 528 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 508, storage device 518, storage unit 522, or signal(s) on channel 528. These and other forms of computer-readable media may be involved in providing one or more sequences of one or more instructions to processor 504 for execution. Such instructions, generally referred to as “computer program code” (which may be grouped in the form of computer programs or other groupings), when executed, enable the computing system 500 to perform features or functions of embodiments of the present invention.

In an embodiment where the elements are implemented using software, the software may be stored in a computer-readable medium and loaded into computing system 500 using, for example, removable storage drive 514, drive 512 or communications interface 524. The control logic (in this example, software instructions or computer program code), when executed by the processor 504, causes the processor 504 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Although the present invention has been described in connection with some embodiments, it is not intended to be limited to the specific form set forth herein. Rather, the scope of the present invention is limited only by the claims. Additionally, although a feature may appear to be described in connection with a particular embodiment, one skilled in the art would recognize that various features of the described embodiments may be combined in accordance with the invention. Moreover, aspects of the invention describe in connection with an embodiment may stand alone as an invention.

Moreover, it will be appreciated that various modifications and alterations may be made by those skilled in the art without departing from the spirit and scope of the invention. The invention is not to be limited by the foregoing illustrative details, but is to be defined according to the claims.

1. A method for generating a media asset, the method comprising:
receiving a set of criteria for selecting media assets;
selecting at least two media assets from a plurality of media assets based on a set of data associated with each of the plurality of media assets and the set of criteria; and
determining a playlist of the selected media assets.

2. The method of claim 1, wherein the playlist comprises an edit specification for at least one of the selected media assets.

3. The method of claim 1, wherein the playlist is one or more edit specifications.

4. The method of claim 1, further comprising tracking the set of data associated with each of the media assets.

5. The method of claim 1, further comprising generating an aggregate media asset based on the playlist.

6. The method of claim 1, further comprising sequentially playing the selected media assets according to the playlist.

7. The method of claim 1, further comprising causing communication of the playlist to a media server.

8. The method of claim 1, wherein the set of data associated with each of the plurality of media assets comprises media asset access patterns.

9. The method of claim 1, wherein the set of data associated with each of the plurality of media assets comprises interestingness data.

10. The method of claim 1, wherein the set of data associated with each of the plurality of media assets comprises a media asset attribute.

11. The method of claim 10, wherein the media asset attribute comprises at least one of duration, tag, source, subject matter, or language of the media asset.

12. Apparatus for generating a media asset, the apparatus comprising:
logic for causing the selection of at least a portion of at least one media asset from a plurality of media assets for use in an aggregate media asset, wherein the selection is based on at least one selection criteria according to a set of data associated with each of the plurality of media assets; and
logic for determining a playlist of the aggregate media asset, the determination satisfying the at least one selection criteria in accordance with the set of data.

13. The apparatus of claim 12, wherein the playlist comprises an edit specification for at least one of the selected media assets.

14. The apparatus of claim 12, further comprising logic for tracking the set of data for the plurality of media assets.

15. The apparatus of claim 12, further comprising logic for communicating the playlist to a media server.

16. The apparatus of claim 12, wherein the at least one selection criteria is based upon a media asset attribute.

17. The apparatus of claim 16, wherein the media asset attribute comprises at least one of a duration, subject matter, tag, source, or language of the media asset.

18-21. (canceled)

22. A computer-readable medium comprising instructions for generating a media asset, the instructions for causing:
receiving a set of criteria for selecting media assets;
selecting at least two media assets from a plurality of media assets based on a set of data associated with each of the plurality of media assets and the set of criteria; and
generating a playlist of the selected media assets.

23. The computer-readable medium of claim 22, wherein the playlist comprises an edit specification for at least one of the selected media assets.

24. The computer-readable medium of claim 22, the instructions further for causing tracking the set of data associated with each of the media assets.

25. The computer-readable medium of claim 22, the instructions further for causing generating an aggregate media asset based on the playlist.

26. The computer-readable medium of claim 22, the instructions further for causing sequentially playing the selected media assets according to the playlist.

27. The computer-readable medium of claim 22, the instructions further for causing communication of the playlist to a media server.

28-29. (canceled)

30. The computer-readable medium of claim 22, wherein the set of data associated with each plurality of media assets comprises a media asset attribute.

31. The computer-readable medium of claim 30, wherein the media asset attribute comprises at least one of duration, tag, source, subject matter, or language of the media asset.
